(19) United States
(12) Patent Application Publication
(10) Pub. No.: US 2016/0246590 A1
(43) Pub. Date: Aug. 25, 2016

(54) Priority Status of Security Patches to RASP-Secured Applications

(71) Applicant: Sounil Yu, Reston, VA (US)

(72) Inventor: Sounil Yu, Reston, VA (US)

(21) Appl. No.: 15/049,077

(22) Filed: Feb. 20, 2016

Related U.S. Application Data
(60) Provisional application No. 62/118,630, filed on Feb. 20, 2015.

(51) Int. Cl. G06F 9/445

(52) U.S. Cl. CPC G06F 8/67

(57) ABSTRACT

Prioritizing software updates in the context of runtime application self-protection (RASP) security. A software update is received for an application software that is running under the control of RASP security, which monitors the application software and works to prohibit one or more runtime operations of the application software. The software update is analyzed to determine whether any runtime operations of the application software that will be affected by the software update are any of the runtime operations prohibited by the RASP security. If the software update affects only runtime operation(s) of the application software that is prohibited, then the priority status of the software update can be downgraded.

### TECHNICAL FIELD

My invention relates to the prioritizing of software security patches in the context of runtime application self-protection.

### BACKGROUND

With malicious attacks on business IT systems becoming more severe and frequent, security patches to fix vulnerabilities are being issued with increasing frequency as well. With its release, a security patch is often designated with a level of criticality, i.e. an indication of how urgently the security patch should be installed. High priority security patches may be designated as being emergency, critical, important, etc. with recommendations that the patch be installed as soon as possible, at the earliest opportunity, etc.

But dealing with security patches can be burdensome. Time and resources must be devoted to properly deploy the security patch, which often involves reviewing, scheduling, evaluating/testing, and distributing the security patches. Many businesses do not have a patch management practice to cope with this burden. For those that do, it is often difficult to meet the recommended timeframe for deploying the patch. There is a need for a way to deploy security patches in a manner that is better aligned with the particular configuration of a business' IT systems.

### SUMMARY

My invention deals with software updates to applications software and improves the way in which the deployment of software updates are prioritized. As used herein, the term “software update” means a revision, addendum, rewrite, or other modification to the application software or its supporting data to fix a problem, improve the software, or otherwise alleviate shortcomings in the software program, but affects less than the complete application software. As used herein, “software update” encompasses patches and services packs. In some cases, the software update is a security update, which is designed to correct a security vulnerability in the application software.

In one aspect, my invention is a method of determining the priority status of a software update for an application software. The method comprises running an application software under the control of a runtime execution controller, wherein the runtime execution controller analyzes and controls the runtime operation of the application software, and wherein the runtime execution controller prohibits one or more runtime operations of the application software. The method further comprises: receiving a software update of the application software; analyzing the software update to determine whether any runtime operations of the application software that will be affected by the software update are any of the runtime operations prohibited by the runtime execution controller; and based on the results of the analysis, assessing a priority status of the software update.

In some embodiments, in the step of assessing the priority status, if the software update affects only those one or more runtime operations of the application software that are prohibited by the runtime execution controller, then the priority status of the software update is downgraded. In some cases, the method further comprises scheduling the software update according to the downgraded priority status. In some cases, the method further comprises deploying the software update according to the downgraded priority status. In some cases, the software update is a security update. In some cases, the software update is designated to have a pre-determined priority status.

In another aspect, my invention is a software product (i.e. a non-transitory computer-readable storage medium storing instructions that when executed by a computer system, causes the computer system to perform the recited steps). The software product may reside on any suitable computer-readable storage medium, such as CD-ROM, DVD, memory, hard disk, flash drive, RAM, ROM, cache, and the like. In one embodiment, the software product implements a method for determining the priority status of a software update for an application software that is under the control of a runtime execution controller, wherein the runtime execution controller prohibits one or more runtime operations of the application software, the method comprising the steps of: receiving a software update of the application software; analyzing the software update to determine whether any runtime operations of the application software that will be affected by the software update are any of the runtime operations prohibited by the runtime execution controller; and if the software update affects only those one or more runtime operations of the application software that are prohibited by the runtime execution controller, then downgrading the priority status of the software update.

In another embodiment, the software product implements a method comprising the steps of continuously monitoring the runtime execution of an application software that is running on the computer system; during the runtime execution of the application software, blocking a runtime operation of the application software according to a predetermined set of one or more runtime operations of the application software that are deemed to be prohibited; receiving an update of the application software; analyzing the software update to determine whether any runtime operations of the application software that will be affected by the software update are any of the runtime operations that are prohibited; and if the software update affects only those one or more runtime operations of the application software that are prohibited, then downgrading the priority status of the software update.

### BRIEF DESCRIPTION OF THE DRAWINGS

FIG. 1 shows a common architecture for a business-enterprise application software.

FIG. 2 shows the runtime flow of data and code logic between the parts of the application software shown in FIG. 1, while under the control of runtime application self-protection (RASP).

FIG. 3 shows an emergency security patch that revises module L2.

FIG. 4 shows an emergency security patch that revises module L4.

### DETAILED DESCRIPTION

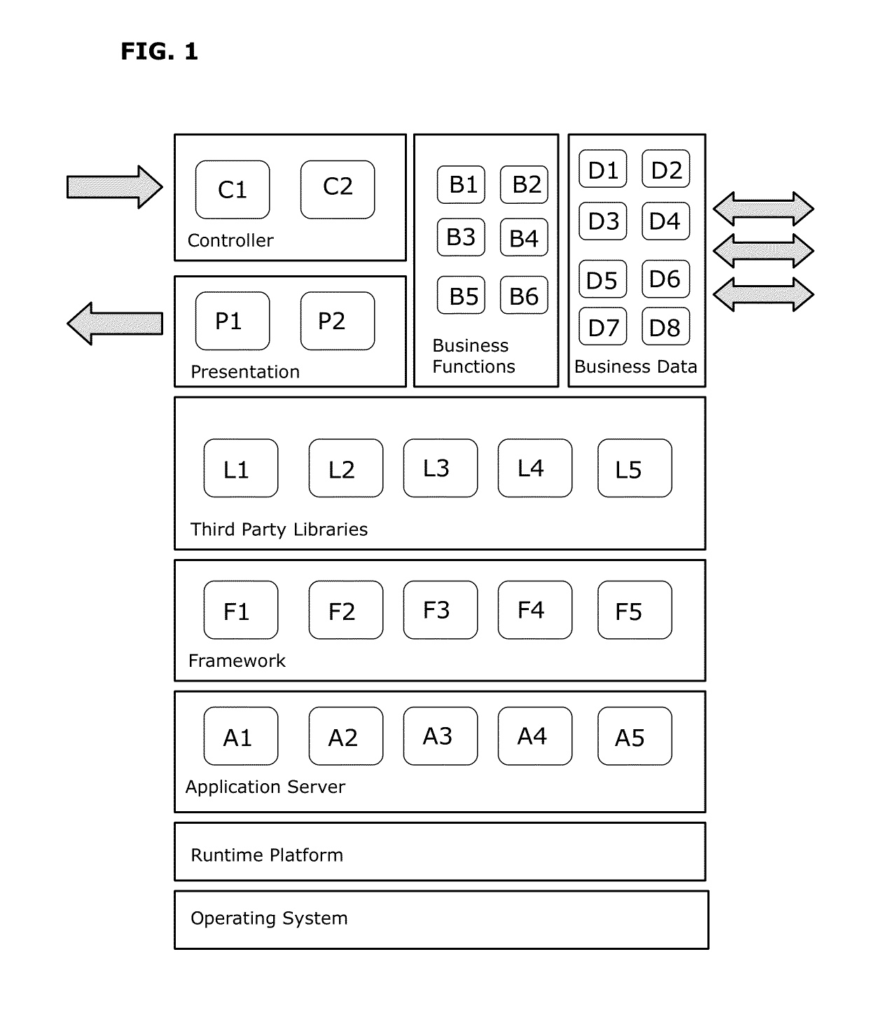

Applications Software. My invention can be implemented with any type of application software, including software for spreadsheets, word processing, email, database management, enterprise resource planning, workforce management, web browsing, and such. As an example, FIG. 1 shows a common architecture for a business-enterprise application software. The application is made up of the presentation layer, controller layer, business function layer, and business data layer. This application layer is built upon a stack of underlying software made up of the operating system, runtime platform, an application server providing an application programming interface (API), an application framework providing tools that implement the APIs, and a set of third party libraries.

In this particular example, the application server layer provides APIs A1-A5. The framework layer provides framework tools F1-F5. The third party library layer provides libraries L1-L5. The presentation layer has modules P1 and P2. The controller layer has modules C1 and C2. The business function layer has function modules B1-B6. The business data has data components D1-D8.

Runtime Execution Controller. In my invention, the operation of the application software is under the control of a runtime execution controller. As used herein, “runtime” means as the application is executing, and as opposed to design-time, compile-time, or deploy-time. The runtime execution controller is a software agent that is built, embedded, deployed, or linked into the application runtime environment and is capable of continuously monitoring the operation of the application software in real-time during its execution. Moreover, the runtime execution controller is capable of automatically controlling the operation of the application software in real-time during its execution. One example of such is runtime application self-protection (RASP) security technology, which is capable of detecting and preventing attacks in real-time. Examples of commercially-available runtime application self-protection (RASP) solutions include those offered by Prevoty, Hewlett-Packard (HP Application Defender), Contrast Security, IBM (Security AppScan) and Waratek (Java Virtual Machine).

The runtime execution controller can be instrumented into the application runtime environment (e.g. Java Virtual Machine [JVM] or .NET Common Language Runtime [CLR]) in any suitable way, such as by adding the feature to an existing application as a plug-in, or by making an API (application programming interface) call, or by having it hosted within the same runtime environment as the application. The runtime execution controller can be physically situated at any suitable location and accessed therefrom, such as in the provider's private cloud, the enterprise's private cloud, or be hosted on-site as a physical or virtual appliance.

The runtime execution controller can detect an operation intended by the application software an instant before it is actually executed. As used herein, the term “operation” in the context of applications software means any behavior, data flow or traffic, communications, interactions, code executions, changes in memory, and other events that occur during the runtime execution of the application software. In some embodiments, my invention is included as part of a runtime execution controller.

Examples of such operations include file and network access, database or data file access, file system access, database queries, directory queries, etc. Further example include control flow, flow of code logic, changes in configuration data, class loading, class linking, function calls, method invocation, application logic execution, invocation of third party libraries, calls to framework and application programming interfaces (API), scripted functions, exception handling, web service calls, input validations, HTTP requests received by the application and HTTP response writing and creation by the application, parameter propagation within code execution, string manipulations live in runtime (e.g. string merging or splitting), etc.

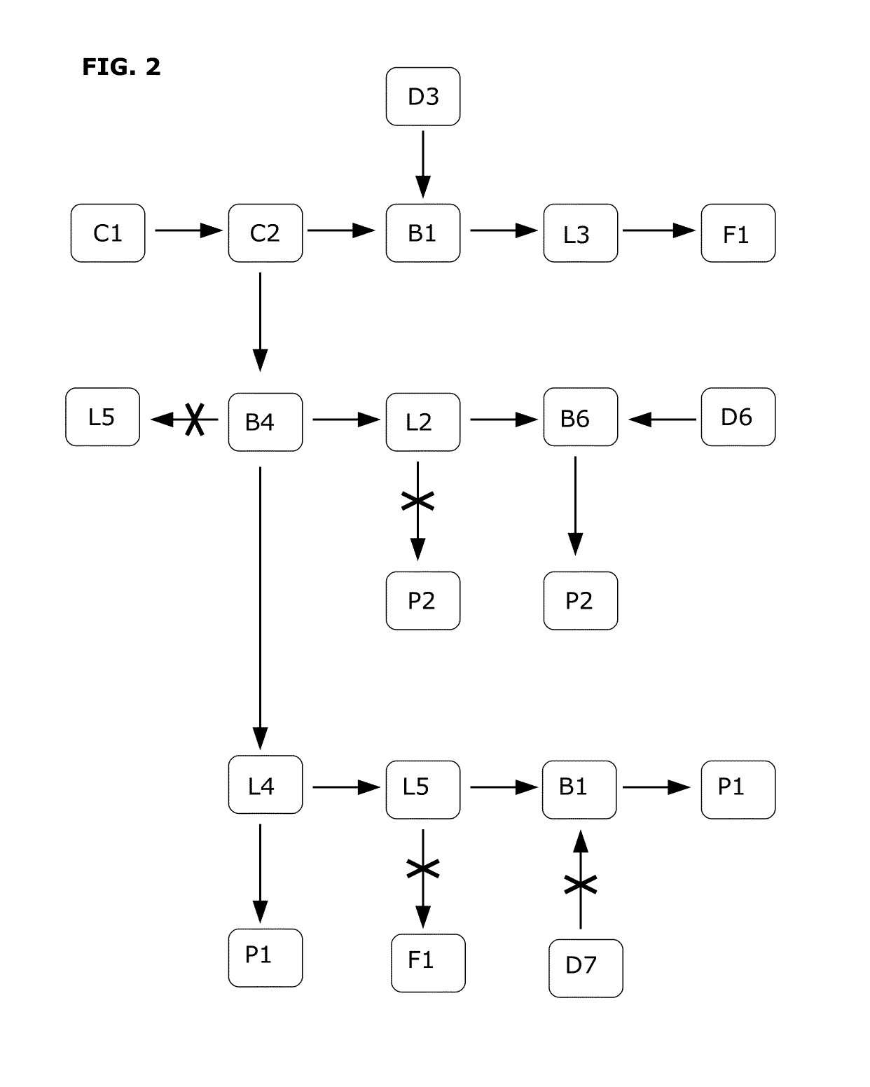

For security purposes, the runtime execution controller is made to prohibit certain abnormal or inappropriate runtime operations of the application software. There may also be subsequent security actions such as user session termination, application termination, an alert being sent to security personnel, or warning being sent to the user. As an example, FIG. 2 shows the runtime flow of data and code logic between the parts of the application software shown in FIG. 1, while under the control of runtime application self-protection (RASP). As seen in FIG. 2, some operations by the application software are prohibited by the RASP controller. Namely, certain types of data flow out of B4 are prohibited (which, in this instance, inappropriate access is attempted by L5 during runtime), certain types of code executions in L2 are prohibited (which, in this instance, would inappropriately attempt to access P2 during runtime), certain types of code executions in L5 are prohibited (which, in this instance, would inappropriately attempt to access F1 during runtime), and certain types of data in D7 flowing into B1 are prohibited.

Prohibition of an operation may be based on any suitable depth of analysis, such as analysis of that particular operation alone in isolation or contextual analysis looking at a series of operations (e.g. based on an analysis of what has led up to the currently pending operation). An example of how this may work to stop an SQL injection attack (a high-priority security risk) is described as follows. The runtime execution controller adds meta-data to untrusted user input (e.g. coming from an HTTP query string) and tracks how this data is used, through any string manipulations, to construct a complete SQL statement to query a database. Before it is passed to the database, the runtime execution controller can check to see if the user-supplied data contains functional statements that change the meaning of the request, indicating this to be an SQL injection attack. Recognizing this as being suspicious activity, the runtime execution controller can block execution of the SQL request and send a warning to the user.

Software Update. An update to the application software is received. The software update may be received in any suitable manner, such as manually, by an automated process, or a combination thereof. The software update affects one or more runtime operations of the application software. In some cases, the software update is designated to have a certain level of priority (e.g. emergency, critical, important, a recommended timeframe for installation, etc.).

In my invention, the software update is analyzed in the context of the application software running under the control of the runtime execution controller. This can be helpful to more accurately assess the priority of the software update. The results of the analysis may show that the software update affects only those runtime operations of the application software that are already prohibited by the runtime execution controller. In such cases, downgrading the priority of the software update may be appropriate.

The analysis of the software update and comparison with the controlled runtime operation of the application software may be performed manually, by an automated process, or a combination thereof. Many businesses employ automated testing of security patches (e.g. to ensure that it will not cause other problems or have an adverse impact on the operation of the application software, or to minimize downtime). As such, my invention may be included as part of an automated software update testing process (e.g. part of an automated patch testing software). The installation of the software update may be performed in any suitable manner, such as manually, by an automated process, or a combination thereof.

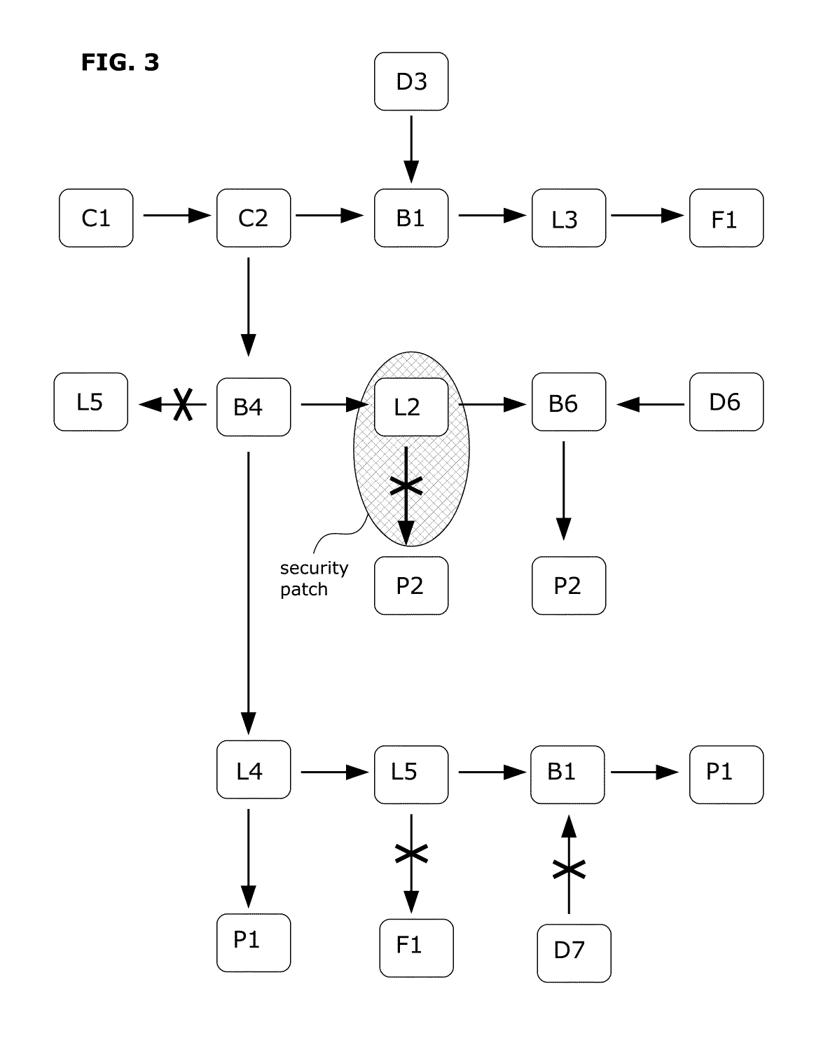

Examples. In the example shown in FIG. 3, a new security patch that fixes a security vulnerability in the application software is released with a designation that it is an emergency update. As shown here, this security patch revises module L2 to prohibit certain types of code executions that abnormally interact with P2. In runtime, the runtime execution controller would prohibit the same type of abnormal interaction. Because this restriction is already imposed by the runtime execution controller, the emergency status of the security patch can be downgraded (e.g. to being a critical-level patch).

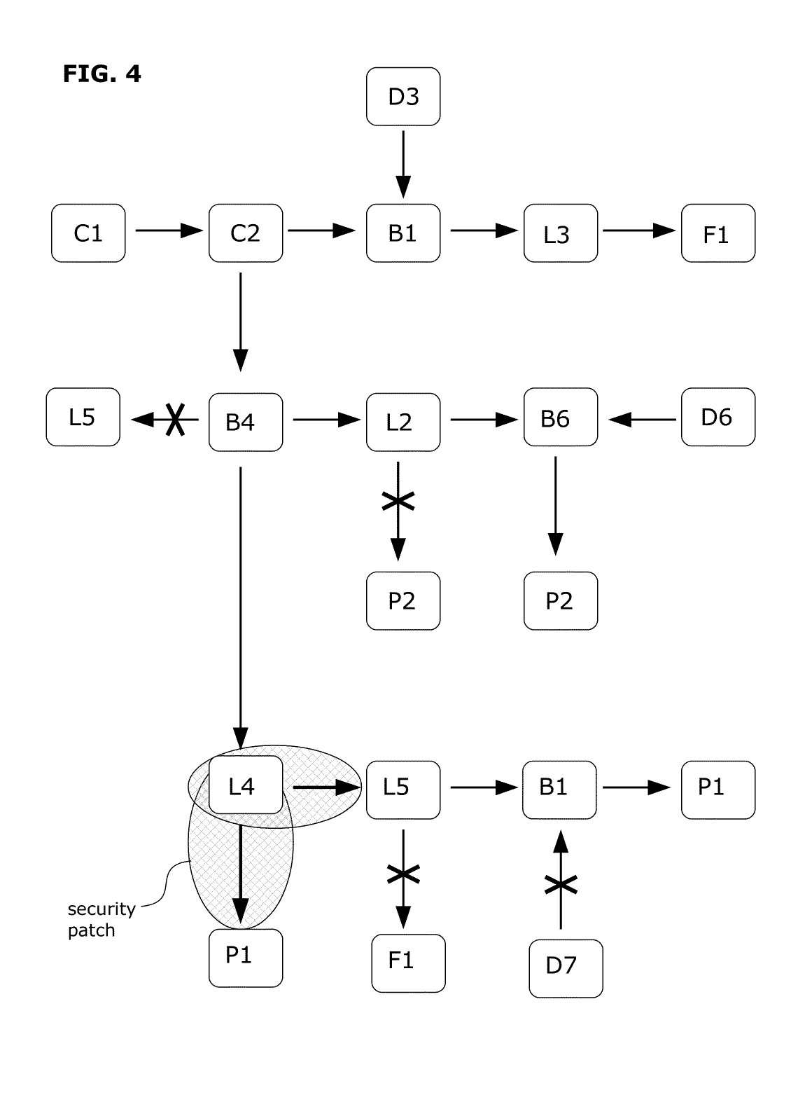

In the example shown in FIG. 4, a different security patch that fixes a security vulnerability in the application software is released with a designation that it is an emergency update. As shown here, this security patch revises module L4 to prohibit certain types of code executions that abnormally interact with P1 and L5. In runtime, the runtime execution controller imposes no restrictions on these interactions. In this situation, maintaining the emergency status of the security patch may be appropriate.

The foregoing description and examples have been set forth merely to illustrate my invention and are not intended to be limiting. Each of the disclosed aspects and embodiments of my invention may be considered individually or in combination with other aspects, embodiments, and variations of my invention. In addition, unless otherwise specified, the steps of the methods of my invention are not confined to any particular order of performance. Modifications of the disclosed embodiments incorporating the spirit and substance of my invention may occur to persons skilled in the art, and such modifications are within the scope of my invention.

Any use of the word “or” herein is intended to be inclusive and is equivalent to the expression “and/or,” unless the context clearly dictates otherwise. As such, for example, the expression “A or B” means A, or B, or both A and B. Similarly, for example, the expression “A, B, or C” means A, or B, or C, or any combination thereof.

1. A method of determining the priority status of a software update for an application software, the method comprising:
running an application software under the control of a runtime execution controller, wherein the runtime execution controller analyzes and controls the runtime operation of the application software, and wherein the runtime execution controller prohibits one or more runtime operations of the application software;
receiving a software update of the application software, wherein the software update is designated to have a pre-determined priority status;
analyzing the software update to determine whether any runtime operations of the application software that will be affected by the software update are any of the runtime operations prohibited by the runtime execution controller; and
based on the results of the analysis, assessing the priority status of the software update.

2. The method of claim 1, wherein in the step of assessing the priority status, if the software update affects only those one or more runtime operations of the application software that are prohibited by the runtime execution controller, then downgrading the priority status of the software update.

3. The method of claim 2, the method further comprising scheduling the software update according to the downgraded priority status.

4. The method of claim 3, the method further comprising deploying the software update according to the downgraded priority status.

5. The method of claim 2, wherein the runtime execution controller is a runtime application self-protection (RASP) security.

6. The method of claim 5, wherein in the step of assessing the priority status, if the software update affects only those one or more runtime operations of the application software that are prohibited by the RASP security, then downgrading the priority status of the software update.

7. The method of claim 6, the method further comprising scheduling the software update according to the downgraded priority status, deploying the software update according to the downgraded priority status, or both.

8. A software product that implements on a computer system, a computer-implemented method for determining the priority status of a software update for an application software that is under the control of a runtime execution controller, wherein the runtime execution controller prohibits one or more runtime operations of the application software, the computer-implemented method comprising the steps of:
receiving a software update of the application software, wherein the software update is designated to have a pre-determined priority status;
analyzing the software update to determine whether any runtime operations of the application software that will be affected by the software update are any of the runtime operations prohibited by the runtime execution controller; and
if the software update affects only those one or more runtime operations of the application software that are prohibited by the runtime execution controller, then downgrading the priority status of the software update.

9. The software product of claim 8, wherein in the step of assessing the priority status, if the software update affects only those one or more runtime operations of the application software that are prohibited by the runtime execution controller, then downgrading the priority status of the software update.

10. The software product of claim 9, the computer-implemented method further comprising scheduling the software update according to the downgraded priority status, deploying the software update according to the downgraded priority status, or both.

11. The software product of claim 8, wherein the runtime execution controller is a runtime application self-protection (RASP) security.

12. The software product of claim 11, wherein in the step of assessing the priority status, if the software update affects only those one or more runtime operations of the application software that are prohibited by the RASP security, then downgrading the priority status of the software update.

13. The software product of claim 12, the computer-implemented method further comprising scheduling the software update according to the downgraded priority status, deploying the software update according to the downgraded priority status, or both.

14. A software product that implements on a computer system, a computer-implemented method comprising the steps of:
continuously monitoring the runtime execution of an application software that is running on the computer system;
during the runtime execution of the application software, blocking a runtime operation of the application software according to a predetermined set of one or more runtime operations of the application software that are deemed to be prohibited;
receiving an update of the application software, wherein the software update is designated to have a pre-determined priority status;
analyzing the software update to determine whether any runtime operations of the application software that will be affected by the software update are any of the runtime operations that are prohibited; and
if the software update affects only those one or more runtime operations of the application software that are prohibited, then downgrading the priority status of the software update.

15. The software product of claim 14, the computer-implemented method further comprising scheduling the software update according to the downgraded priority status.

16. The software product of claim 15, the computer-implemented method further comprising deploying the software update according to the downgraded priority status.

17. The software product of claim 14, wherein the application software is secured by runtime application self-protection (RASP) security.

18. The software product of claim 17, wherein in the step of assessing the priority status, if the software update affects only those one or more runtime operations of the application software that are prohibited by the RASP security, then downgrading the priority status of the software update.

19. The software product of claim 18, the computer-implemented method further comprising scheduling the software update according to the downgraded priority status, deploying the software update according to the downgraded priority status, or both.
